(19) United States
(12) Patent Application Publication
(10) Pub. No.: US 2014/0255001 A1
(43) Pub. Date: Sep. 11, 2014

(54) System for Simultaneously Playing Video Files in a Platform Independent Environment

(71) Applicants: Gustavo Malagón, Washington, DC (US); Guillermo Echevarria, Miami, FL (US)

(72) Inventors: Gustavo Malagón, Washington, DC (US); Guillermo Echevarria, Miami, FL (US)

(73) Assignee: David Melchor, San Juan, PR (US)

(21) Appl. No.: 14/193,926

(22) Filed: Feb. 28, 2014

Related U.S. Application Data
(60) Provisional application No. 61/770,472, filed on Feb. 28, 2013.

(51) Int. Cl. H04N 5/445; H04N 5/265

(52) U.S. Cl. CPC H04N 5/44591; H04N 5/265
USPC 386/230

(57) ABSTRACT

The present disclosure is directed toward a computer-readable medium, tangibly embodied. The medium includes instructions for receiving log-in information and a first plurality of video files from a first user. The medium further includes instructions for defining a first array of video clips based on each received video file; individually playing each video file on the first array of video clips simultaneously; and receiving a second plurality of video files from a second user. The second plurality of video files comprises at least one particular indicia or identifier associated with at least one of said second plurality of video files. The particular indicia comprising keywords, set of keywords, hash tags, computer icons and any distinctive electronic mark. The medium also includes instructions for calculating a first social media index at least partially based on the received second plurality of video files and the at least one particular indicia; and for defining a second array of video clips based on the calculated social media index.

### RELATED APPLICATIONS

This application claims the benefit of priority of U.S. provisional application 61/770,472, filed on Feb. 28, 2013.

### STATEMENT REGARDING FEDERALLY SPONSORED RESEARCH AND DEVELOPMENT

N/A

### BACKGROUND OF THE DISCLOSURE

1. Technical Field

The present disclosure is directed to the field of video processing and, more particularly, to a platform-independent tool for processing and displaying video files in a social setting.

2. Discussion of the Background

Data management, such as the processing of video files, has typically been a complex and time-consuming endeavor. While image files are routinely uploaded and shared on different social applications, users have been less enthusiastic about sharing video files. While users undoubtedly continue to create and store a considerable amount of video files of their trips, family events, and friends, most of these remain stored inside a hard drive somewhere never to be seen again after the initial transfer from camera to storage.

One may argue that perhaps most of these people lack the time or skills necessary to edit their videos into a cohesive and appealing composition. In addition, even more people lack the time or the interest to sit through more than a few minutes of your latest beach vacation or birthday party.

In response, customers have been seeking ways to improve understanding of Multimedia content management including, for example, displaying and processing video files. While a customer has particular video processing and display capabilities, the ability of the customer to share and utilize said video depends on the particular capabilities of the receiving user(s). Furthermore, one customer's particular needs may be different to those of another similarly situated individuals, even if they use similar equipment or seek to use the data in the similar industry. Moreover, certain customers may have different degrees of previous knowledge, as well as experience in other projects. Without an appropriate tool, the task of processing a video file for display, may be a time-consuming and, ultimately futile endeavor.

Although prior media management methods may allow a user to view a single video in linear fashion (i.e., from start to finish), this approach may not maximize the time or the hardware resources each user has. In particular, it may not allow a particular customer or user to visualize different segments of the same video file or several segments gathered from other videos at the same time in the same user interface. Furthermore, it may not allow a particular customer or user to visualize different segments of the same video file or a several segments gathered from other videos at the same time on different platforms. Similarly, the standard approach to video playback does not contemplate a platform capable of playing different segments of the same video file or several segments gathered from other videos at the same time and including the option of sharing the different video segments with other users. Current playback methods do not contemplate managing or altering the original array of video segments based on feedback received from other users. That is, current playback methods do not dynamically manage an array of video segments based on the social feedback received from other users.

The present disclosure is directed to overcoming the one or more problems or disadvantages associated with the prior art.

### SUMMARY OF THE DISCLOSURE

In accordance with one aspect, the present disclosure is directed toward a computer-readable medium, tangibly embodied. The medium includes instructions for receiving log-in information and a first plurality of video files from a first user. The medium further includes instructions for defining a first array of video clips based on each received video file; individually playing each video file on the first array of video clips simultaneously; and receiving a second plurality of video files from a second user. The second plurality of video files comprises at least one particular indicia or identifier associated with at least one of said second plurality of video files. The particular indicia comprising keywords, set of keywords, hash tags, computer icons and any distinctive electronic mark. The medium also includes instructions for calculating a first social media index at least partially based on the received second plurality of video files and the at least one particular indicia; and for defining a second array of video clips based on the calculated social media index. The social media index can be generated by several alternatives. In exemplary embodiment the social media index is based on a trending score generated from the amount of times that an identifier, such as a hashtag, or geolocated area is associated with a video.

According to another aspect, the present disclosure is directed toward a method for playing video files. The method includes receiving log-in information and a first plurality of video files from a first user. The method also includes defining a first array of video clips based on the received video files; individually playing each video file on the first array of video clips simultaneously; and receiving a second plurality of video files from a second user. The second plurality of video files comprises at least one particular indicia associated with at least one of said second plurality of video files. The method also includes calculating a first social media index at least partially based on the received second plurality of video files and the at least one particular indicia; and defining a second array of clips based on the calculated social media index.

### BRIEF DESCRIPTION OF THE DRAWINGS

The accompanying drawings, which are incorporated herein, constitute part of the specifications and illustrate the preferred embodiment of the disclosure.

FIG. 1 is a block illustration of an exemplary disclosed system for simultaneously playing video files in a platform-independent environment;

FIG. 2 is a schematic illustration of an exemplary database which may be included in the disclosed system of FIG. 1;

FIG. 3 is a schematic illustration of a web browser displaying the content of an exemplary Multi-Video Sharing System;

FIGS. 4A and 4B is a schematic illustration of a web browser for uploading content to an exemplary Multi-Video Sharing System;

FIG. 5 is a schematic illustration of a mobile browser displaying the content of an exemplary Multi-Video Sharing System;

FIG. 6 is a schematic illustration of a mobile browser uploading content to an exemplary Multi-Video Sharing System; and

FIG. 7 is a flowchart illustration of an exemplary method of operating the system for simultaneously playing video files in a platform-independent environment, as shown in FIG. 1.

FIG. 8 is a schematic illustration regarding assembling documents from different users into an exemplary Multi-Video Sharing System.

FIG. 9 is a flow diagram regarding assembling documents from different users into an exemplary Multi-Video Sharing System based on particular indicia.

### DETAILED DESCRIPTION

The embodiments of the invention disclosed herein may be implemented, through the use of general-programming languages (such as C or C++). The program code can be disposed in any known computer-readable medium including semiconductor, magnetic disk, or optical disk (such as CD-ROM, DVD-ROM). As such, the code can be transmitted over communication networks including the Internet.

In the present disclosure, the terms “computer program medium” and “computer-usable medium” are used to generally refer to media such as a removable storage unit or a hard disk drive. Computer program medium and computer-usable medium can also refer to memories, such as system memory and graphics memory which can be memory semiconductors (e.g., DRAMs, etc.). These products are examples of how to provide software to a computer system.

The embodiments are also directed to computer products comprising software stored on any computer-usable medium. Such software, when executed in one or more data processing devices, causes a data processing device(s) to operate as described herein or, allows for the synthesis and/or manufacture of computing devices (e.g., ASICs, or processors) to perform embodiments described herein. Embodiments employ any computer-usable or -readable medium, and any computer-usable or -readable storage medium known now or in the future. Examples of computer-usable or computer-readable mediums may include, but are not limited to, primary storage devices (e.g., any type of random access memory or read-only memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.).

For purposes of this discussion, the term “module” may include at least one of software, firmware, and hardware (such as one or more circuits, microchips, or devices, or any combination thereof), and any combination thereof. In addition, it will be understood that each module may include one or more components within an actual device, and each component that forms a part of the described module can function either cooperatively or independently of any other component forming a part of the module. Conversely, multiple modules described herein may represent a single component within an actual device. Further, components within a module may be in a single device or distributed among multiple devices in a wired or wireless manner.

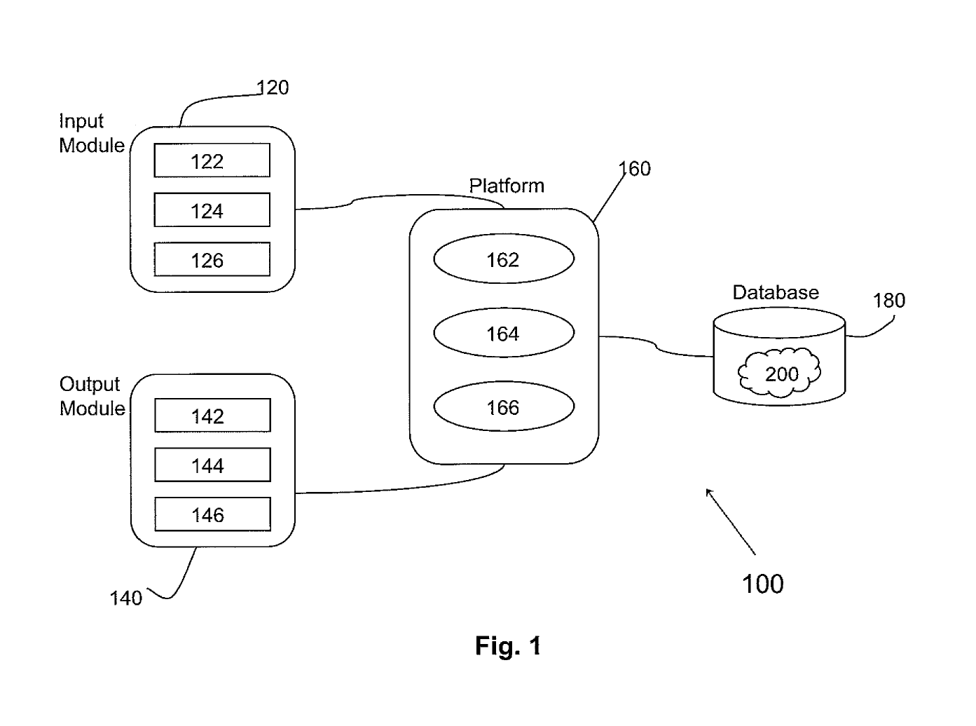

FIG. 1 illustrates a Multi-Video Sharing System 100. System 100 may include an input module 120, an output module 140, and a computing platform 160. Computing platform 160 may include or may be otherwise operatively coupled to a database 180, which may be stored in a memory 200. Database 180 may include more than one database or another type of electronic repository. Computing platform 160 may include the software functionality and hardware capabilities to implement multi-video sharing strategies through input module 120 and access, read, and write to database 180.

The results of data received from a user may be provided as output from computing platform 160 to output module 140 for printed display, viewing, and/or further communication to other system devices. Such output may include, for example, printout of a screenshot corresponding to an individual video file, to a selection of individual video clips or to the entire grid on the page comprising the video clips.

In a preferred embodiment of the present disclosure, the output module 140 may render files using a display. The display may include multiple video clips arranged in a grid formation which play automatically and at the same time, without having to engage each video individually via the input module 120. That is, in a preferred embodiment of the present disclosure, a computing platform 160 may be configured to display an array of video clips which play automatically upon selecting or activating the output module 140, which may include a monitor, screen, projector or similar panel depicting the array of video clips. In the preferred embodiment, each of the video clips automatically displays upon selecting or activating the output module 140 and continues to play in a looped sequence unless and until the user selects or activates the input module 120 to perform some other function, as described in detail below. In an embodiment, each of the video clips corresponds to a video file that runs for a pre-determinate period of time, such as less than one minute from start to finish. Each of the video clips is automatically activated and displayed simultaneously in a looped sequence.

It is also contemplated, however, that the output module 140 may further provide technical data such as performance estimates and log reports for error tracking and debugging. Data provided by output module 140 may additionally or alternatively include metadata for each video clip, which a user may desire to obtain from the Multi-Video Sharing System for his or her reference. Such metadata may include information about a user or the particular device used to generate the video, such as a user's name or nickname, email account, platform identifier and operating system used by the computing platform 160. Additionally or alternatively, the metadata may relate to the video file itself, such as to include information on the date and time the video clip was taken, accessed, modified, or edited. Output from computing platform 160 can also be provided to database 180, which may be utilized as storage device for video files and video-related data pertaining to a user. This form of output may be stored in a folder corresponding to the user's account or under a predetermined directory folder.

In the embodiment of FIG. 1, computing platform 160 may include a personal computer (PC), a mainframe computer, a laptop computer, a web-enabled video camera device or a mobile video capture device (such as a smartphone or tablet apparatus) configured to perform various functions and operations. That is, computing platform 160 may include software functionality and hardware capabilities to implement multi-video sharing strategies according to an embodiment of the disclosure. Computing platform 160 may be implemented, for example, by a general purpose apparatus selectively activated or configured by software stored in memory of the apparatus, or may be a specially constructed computing platform for carrying out the features and operations of the Multi-Video Sharing System 100. It is contemplated, however, that in addition to the computing platform 160 having locally executable software to perform the multi-video sharing strategies of the present disclosure, these features may be accessible via a web-browser without the need to download and install an application on every device in which the user desires to experience the simultaneous display of multiple video clips in the manner enabled by the present disclosure. That is, the multi-video sharing strategies of the present disclosure may reside in the cloud thus executable over a web browser or may reside locally, such as in a smartphone application downloaded from an application market or preloaded by the smartphone's manufacturer.

In order to perform these tasks, computing platform 160 may also be implemented or provided with a wide variety of components or subsystems including, for example, one or more of the following: a processor 162, a co-processor 164, a register 166, and/or other data processing devices and subsystems. Computing platform 160 may also communicate or transfer video clips and video-related data as well as and feedback provided by the user of third parties via input module 120 and/or output module 140 through the use of wired connections, wireless connections or other communication link, as shown in FIG. 1.

In an exemplary embodiment, a firewall may prevent access to the computer platform 160 by unauthorized outside entities. It is further contemplated that computing platform 160 may require user authentication, such as password verification, biometrics, pattern recognition, speech recognition or similar means, in order to prevent unauthorized users from gaining access to sensitive information, video files, and multi-video sharing preferences associated with a particular individual.

It is further contemplated that communication between computing platform 160 and input and output modules 120, 140 can be achieved through the use of a network architecture (not shown). In such an embodiment, the network architecture may include, alone or in any suitable combination, a telephone-based network (such as a PBX or POTS), a local area network (LAN), a wide area network (WAN), a VPN, a dedicated intranet, and/or the Internet. Further, the network architecture may include any suitable combination of wired and/or wireless components and systems necessary in order to carry out the multi-video displaying and sharing strategies of the present disclosure. By using dedicated communication links or a shared network architecture, computing platform 160 may be located in the same location or at a location geographically remote from input and/or output modules 120,140.

Input module 120 may include a wide variety of devices to receive and/or provide the data as input to computing platform 160. As illustrated in FIG. 1, input module 120 may include an input device 122, a storage device 124, and/or a network interface 126. Input device 122 may include a keyboard, mouse, touch screen, stylus, touchpad, disk drive, video camera, magnetic card reader, or any other suitable input device for communicating data to computing platform 160.

Memory 200 may be implemented with various forms of memory or storage devices, such as read-only memory (ROM) devices and random access memory (RAM) devices. Storage device 124 may include a memory tape, disk drive, a flash memory card, an SD card or a microSD card for reading and providing data (including video files) as input to computing platform 160. Network interface 126 may receive data over a network (such as a LAN, a WAN, a mobile network, such as EDVO, 3G, 4G, GSM, an intranet or the Internet) and provide the same data as input to computing platform 160. For example, network interface 126 may be selectively connected or connectable to a public or private database for purposes of receiving information about one or more users, video files, video clips and video-related data from computing platform 160.

Output module 140 may include a display 142, a printer device 144, and/or a network interface 146 for receiving the information provided as output from computing platform 160. As indicated above, the output module 140 from computing platform 160 may include a display including multiple video clips arranged in a grid formation which plays simultaneously and automatically, without having to engage each video individually via the input module 120. The output from computing platform 160 may be displayed or viewed through display 142 (such as a CRT, LCD, CSTN, TFT, TFD, OLED, capacitive, resistive, AMOLED, super AMOLED, haptic/tactile, Gorilla glass or Retina type) and printer device 144. Network interface 146 may also facilitate the communication of the output from computing platform 160 over a network (such as a LAN, a WAN, a mobile network, such as EDVO, 3G, 4G, GSM, an intranet or the Internet) to remote locations for debugging, reviewing or providing backup.

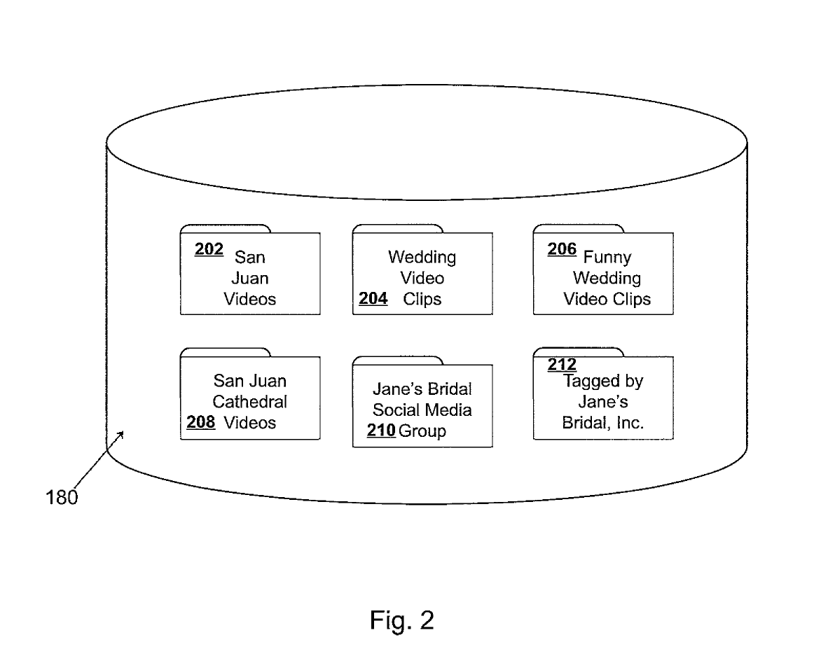

Video files and video-related information associated to individual users or group of users may be stored in memory 200 of database 180, FIG. 2 illustrates one embodiment of database 180, which may include information about one or more users, video files, and video-related data. Database 180 may also include data relevant to the population of users, content generators, content uploaders as a whole and/or to certain segments of the population. Database 180 may further include demographic data, shopping habits, web searches, most visited web sites, and related behavioral information in order to create and/or edit the directory structure stored therein. For example, a user may upload a video of a wedding at the San Juan Cathedral in Old San Juan, Puerto Rico. In response to the uploaded file being tagged with particular indicia, such as a set of keywords, hash tags, computer icon or any indicia pertaining to the San Juan Cathedral, the system 100 may create a directory within the database 180 to group video files which may be uploaded with similar particular indicia. These videos may be identified based on the city or town 202, the activity depicted therein 204, the characterization or description of the activity depicted 206, and the venue for a particular activity or event 208. Additionally or alternatively, the database 180 may include a file structure which is built and updated based on the information and/or video files shared by a particular group in a given social media application 210. Lastly, it is contemplated that an individual file entity 212 may be created and maintained according to each specific user, including both individuals as well as businesses.

FIG. 2 illustrates an exemplary embodiment for the database 180. Nonetheless, it is contemplated, that the video file structure of database 180 may be dynamically created, organized, and/or maintained based on either information pertaining to the user (or group of users) or to the video files (or group of video files). Database 180 may include additional information within the City or Town folder 202. City or Town folder 202 may include, for example, information about different locations and activities, as well as demographic data. In addition, the videos stored under the City or Town folder 202 as well as under the venue folder 208 may be supplemented with geographic characteristic information. This location-specific geographic information may include sample background images that recreate emblematic features of a city or venue. For example, such geographic characteristics information may include maps, images of the Atlantic Ocean, Caribbean Sea, the City of San Juan or any combination thereof. It is contemplated that such geographic characteristic information may be used by the system 100 as background or desktop image for the multi-video presentation displayed on the user's computer or mobile device. Furthermore, it is also contemplated that the geographic characteristic information may not be static within the application. That is, it is contemplated that said geographic characteristic information may be shown, edited or deleted, depending on the social media feedback detected by the system 100.

The video clips filed under the Activity folder 204 may be supplemented with data pertaining to the type of wedding ceremony. For example, such file structure may serve to identify and subsequently group wedding ceremonies performed pursuant to a particular custom or faith. Similarly, Activity Characterization folder 206 may serve to further correlate the videos sharing these indicia. For example, database 180 may be configured or updated to allow users to rate or “like” individual video clips or entire pages of multi-video presentations. Users may assign ratings, such as high, medium, or low and assist in further associating and grouping the files within the system 100. It is contemplated that the system 100 may also include a default rating for this type of folder (or any other data structure implemented according to the disclosure), in case a user does not select a high, medium, or low rating for a given file.

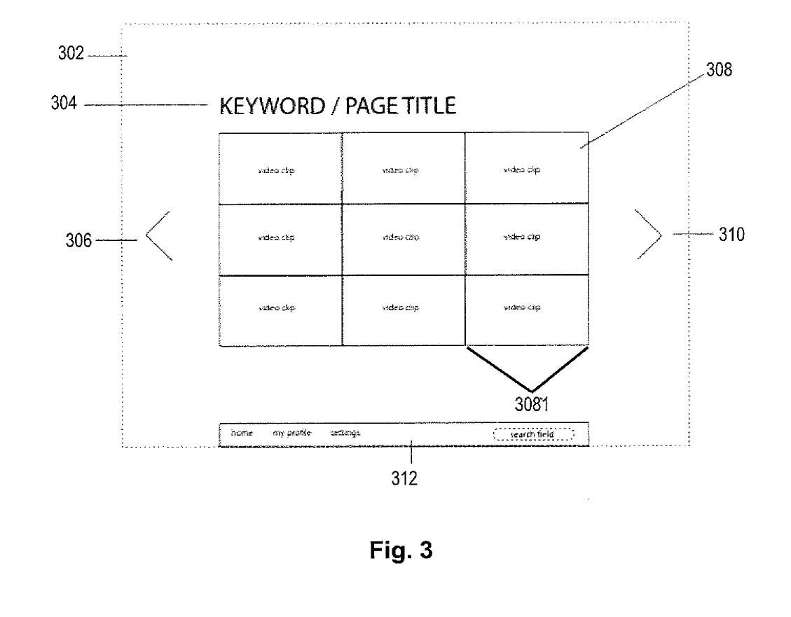

As illustrated in FIG. 3, system 100 may display various types of content, web-based, downloaded or otherwise gathered from one or more sources. For example, content from database 180 may be accessed and viewed via an exemplary web browser 302. Web browser 302 may display content presenting multiple video clips in one page 308. The multiple video clips 308 may be configured such that all clips automatically play at the same time without having to engage each video individually.

According to a preferred embodiment of the disclosure, the content shown by the multiple video clips 308 is presented in the form of a grid. In the example shown in FIG. 3, the multiple video clips 308 are arranged in a 3×3 grid 3081. It is contemplated, however, that grids with more or less video clips per row and/or per column are possible and within the scope of the present disclosure. To access or view more videos, a user may simply operate the Back 306 and Forward 310 options offered by the web browser 302.

Web browser 302 may further include particular indicia feature 304. The particular indicia feature 304 may serve to implement the social networking features 312 of system 100. For identification purposes and to prevent abuse by spammers, users may be prompted to create a profile using the My Profile option of the social networking features 312. Among these social features, the search fields allow a user to uncover and view other user's content. For example, the particular indicia feature 304 may allow other users to access the multiple video clips and assign particular indicia to either the entire page (i.e., grid) or to individual video clips. It is also contemplated that a user may share his or her page of multiple video clips 308 with other users who may then select particular indicia from existing options.

In a preferred embodiment of the present disclosure, it is contemplated that the particular indicia feature 304 provides real-time feedback to the system 100. In turn, the system 100 may alter or prioritize the individual order of each video clip in the grid or the hierarchy of the user's page (i.e., grid) in relation with other users' pages. Moreover, the particular indicia feature 304 may be combined with a ratings system. A rating system may allow a visiting user to assign ratings, such as high, medium, or low, thus further assisting in associating/grouping the video files or video clips within the grid and the pages within the system 100.

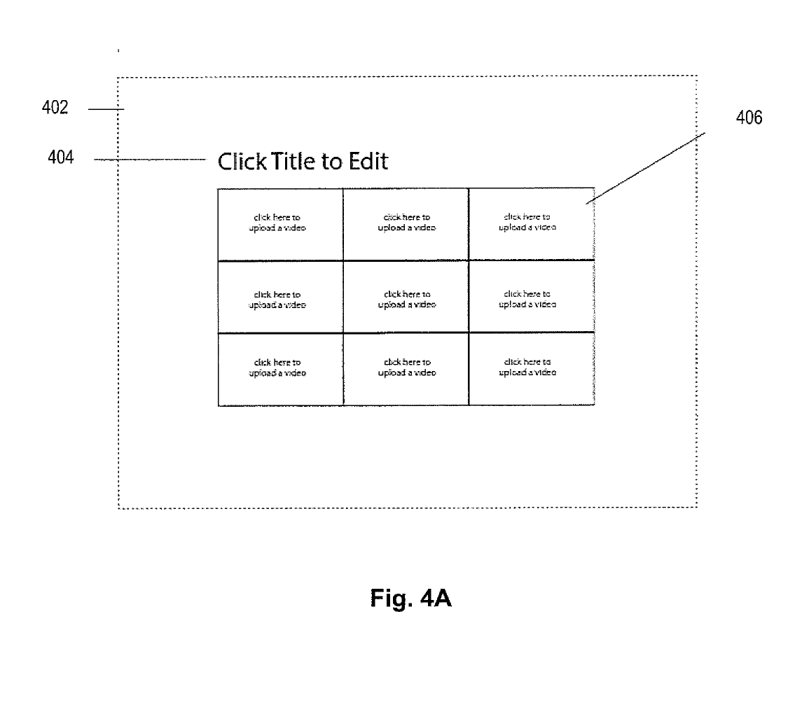

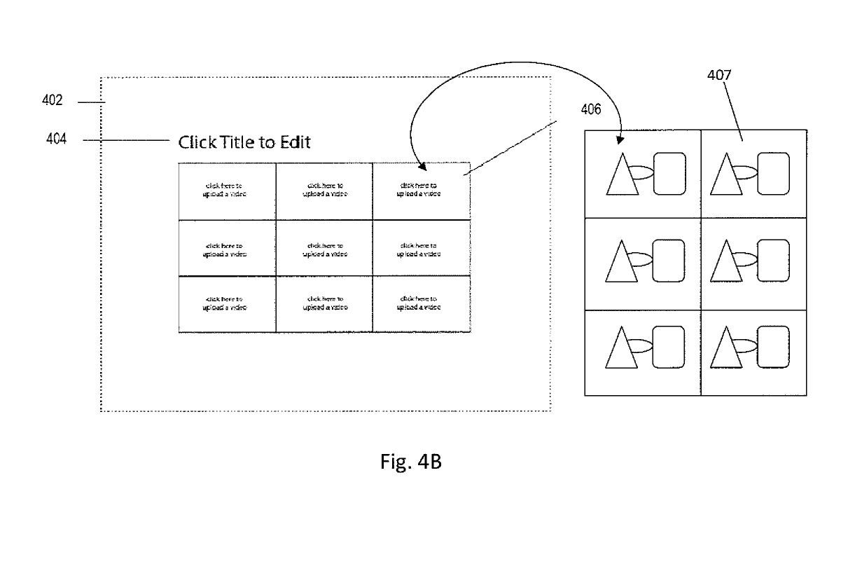

It is also contemplated that passive users may be limited to viewing and tagging the video clips displayed on the web browser 302. Further it is contemplated that active users may upload content, including video clips of their own (preferably with a pre-determinate period of time) using the browser 402 shown in FIG. 4A. Said active users may also assign a tag or particular indicia 404 to the video clip(s) 406 they contribute to the page 402. Thus, the multiple video clips 406 may be uploaded by a single active user or may be the result of a contribution of two or more active users. Users, active or passive, may search for video clips or pages (i.e., grid of video clips) by particular indicia. Once the retrieved clips start playing automatically at the same time without having to engage each video individually, the visiting user may opt to contribute one or more videos of his or her own to the existing grid.

It is important to understand that the active user may upload content via a drag-and-drop mechanism, as shown in FIG. 4B. In such case, the active user just selects the electronic document 407, such as the video file, to be dragged from the input module 120 to the computing platform 160. The selected information is then dragged to a drop target associated to the computing platform 160 using a pointing device that allows a user to virtually grab the video file and drag it to the drop target. The computing platform 160 associated with the drop target receives a sequence of instructions that extracts the information and saved it into the database 180.

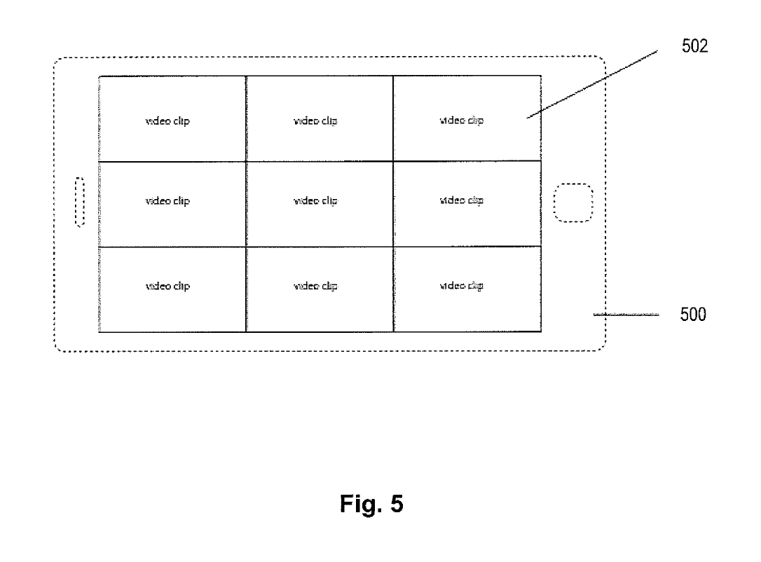

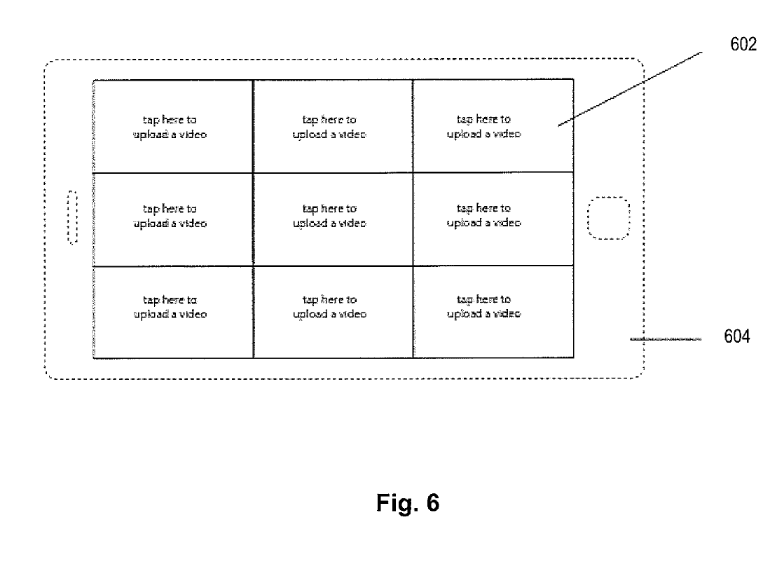

As shown in FIG. 5, because the system 100 is platform-independent, users experiencing a page of videos clips with an active grid 502 on a smartphone or tablet device 500 will see the same content with the same features as those users who access the system 100 via a PC or desktop computer. Conversely, as shown in FIG. 6, users uploading videos to a page of existing unpopulated grids 602 using a smartphone or a tablet device 604 will see the results and will access the same features as those available to users who use a PC or a desktop computer to access the system 100.

Web browser 302 may also include background images or additional information supplementing the multiple video clips 308. Additional location-specific geographic information may include sample background images that recreate emblematic features of a city or venue. For example, such geographic characteristics information may include maps, images of a city's skylines, sea, wildlife, flora or any combination thereof.

It is contemplated that web browser 302 may include multimedia controls. For example, web browser 302 may include a feature for selectively enabling audio for each file comprising the multiple video clips 308 (not shown). The audio selected may include recorded audio corresponding to the individual file under review. Additionally or alternatively, the enabled audio may correspond to a song previously selected and/or purchased by an active user. It is contemplated that the enabled audio may instead consist of preselected songs made available by the administrators of the system 100. Lastly, the enabled audio may provide spoken instructions to the user on how to properly operate the web browser 302. To address the needs of users with a disability, it is contemplated that the multiple video clips 308 may play with enhanced audio or with subtitles, depending on the particular embodiment of the present disclosure.

Web browser 302 may further include a section providing a user with the alternative of saving the particular selections, such as the populated background information during execution or upon completion. Web browser 302 may further provide controls for selecting a zoom of the background display information or of an individual video clip comprising the grid 3081. Web browser 302 may further provide an option for easily switching between pages (i.e., grids 3081) for several users without having to enter the user's data or searching again for the same particular indicia.

It is further contemplated that system 100 may obtain video files and video-related information from sources other than database 180, which may be either public or private. This information may be obtained in order to develop, deliver, and/or execute the features and operations of the Multi-Video Sharing System 100.

Although the embodiments disclosed herein may include a particular network configuration, embodiments of the present disclosure may be implemented in a variety of data communication network environments using software, hardware, or a combination of hardware and software to provide the processing functions.

Those skilled in the art will appreciate that all or part of systems and methods consistent with the present disclosure may be stored on or read from other computer-readable media. System 100 may include a computer-readable medium having stored thereon machine executable instructions for performing, among other things, the methods disclosed herein. Exemplary computer readable media may include secondary storage devices, like hard disks, floppy disks, flash cards, SD cards, microSD cards, USB drives, CD-ROMs; a carrier wave received from the Internet; or other forms of computer-readable memory, such as read-only memory (ROM) or random-access memory (RAM). Such computer-readable media may be embodied by one or more components of system 100, such as, for example, computing platform 160, database 180, memory 200, processor 162, or combinations of these and/or other components.

Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described above for each module, script, and daemon. For example, it is contemplated that these programs modules may be implemented using commercially available software tools, using custom object-oriented code written in the C++ programming language, using applets written in the Java programming language, or may be implemented as with discrete electrical components or as one or more hardwired application specific integrated circuits (ASIC) custom designed for this purpose. The media playback, file information, performance results, or related information obtained from the Multi-Video Sharing System 100 for the user's reference may include paper documents, electronic documents, Internet-based documents, and any other suitable media for documentation.

The system 100 may include electronic documents, such as computer files. Such files may be provided to users through various means of transmission, such as email. Internet-based documents may include word processor type files and/or webpages, which may include the video-related information, estimates, and/or reports. Administration of such content may include notifying users in any suitable way of the availability and/or accessibility of such updates and may provide an Internet address for accessing the documents.

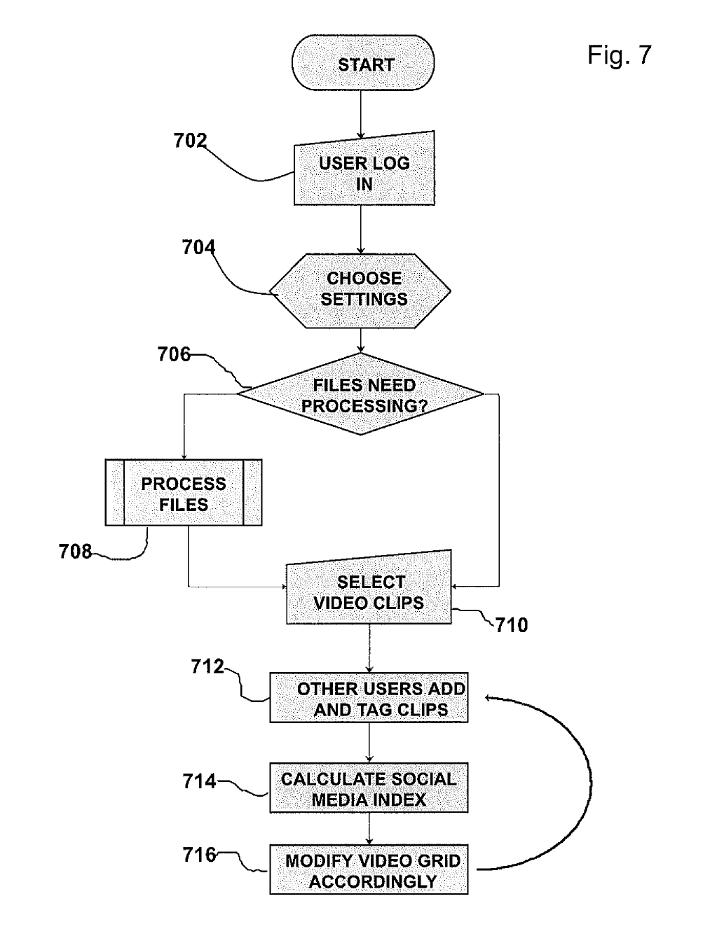

FIG. 7 illustrates a flowchart 700 depicting an exemplary method that utilizes the Multi-Video Sharing System 100 to enable a user to watch an array of videos playing simultaneously and automatically, independent of the computing platform used by the person. The method depicted in flowchart 700 will be described in more detail below.

The disclosed method and system describe a display having multiple video clips arranged in a grid-like pattern which play, simultaneously and automatically, without having to individually engage each video or having to operate the display's input controls. That is, a computing platform displays an array of video clips which play automatically upon selecting or activating an output module, which may include a monitor, screen, projector or similar panel depicting the array of files. Upon running an application or accessing a web-based tool, each video clip automatically plays and continues to do so in a looped sequence, unless and until the user seizes control of the display and enables a different function. In an embodiment, each of the video clips runs for pre-determinate period of time, for example, less than one minute. The system 100 offers the same capabilities and options regardless of which hardware platform uses the person accessing its features via a web portal.

As illustrated in FIG. 7, the first step in the functioning of the Multi-Video Sharing System 100 may include receiving a log-in from a user (Step 702). The log-in procedure may be completed on a graphic user interface (GUI) retrieved via a web browser (such as Internet Explorer, Mozilla Firefox, Opera, Safari or Chrome) via input module 120, including input device 122. During log-in, a user may also enter information related to his or her current location and/or status.

Upon receipt and verification of log-in information, the Multi-Video Sharing System 100 may be initialized. Initialization may include a computing platform receiving from a user a selection of a background image or theme, which may then be graphically rendered for the user (Step 704). The initialization step may be used to tailor or adjust the settings of the video grid to the needs of each user. For example, in an embodiment, a 3×3 grid of video files is superimposed upon a background image. However, it is contemplated that Step 704 may also provide an opportunity for the user to reduce or increase the number of video clips to be displayed on each row and column.

Multi-Video Sharing System 100 may then query the user via the GUI, asking whether the video files are in suitable shape to be imported or whether the file or files needs processing (Step 706). In an embodiment, the multiple video files to be imported by the user are in suitable format and run for less than one minute.

However, it is possible that a selected file may turn out to be an excessively lengthy video. In such case, the system 100 may be capable to take the source video (for example in .mov or .mp4 format), sever the file into smaller segments with the appropriate duration and convert it into formats and sizes suitable to be displayed in both web and mobile applications. (Step 708).

Once the conversion and the segmentation (if necessary) are completed successfully, the user may select the video clips which he or she want to upload to the system 100 using the web browser. The user may choose the video clips by individually clicking, tapping, selecting, and/or dragging the corresponding icons into the previously loaded (but still unpopulated) grid (Step 710). The user may be given the alternative to position the selected videos in the order preferred by the user. Additionally or alternatively, the system 100 may randomly generate the video files grid from user profile, user's social network, location and other factors based on the information stored at the database 180. Similarly, a user may be interested in associating his or her videos file with particular indicia. The user may add particular indicia, assigning it to either the entire page (i.e., video grid) or an individual video clip. It is also contemplated that a user may share his or her page of multiple video files with other users who may then select particular indicia from existing options or create of their own. As part of this step, the Multi-Video Sharing System 100 may further accept or request the user to enter a rating to be assigned with the uploaded content. The first set of files comprising the video grid may serve as a seed or root, since its contents and/or presentation may be linked or dynamically determined by the favorable or unfavorable feedback received from other users in social media.

Once the user successfully uploads the video files along with the corresponding particular indicia (if any), the multiple video files are now available on a social application environment. Third party users may now access the uploaded video grid and contribute video files to be added to the grid (Step 712). Additionally or alternatively, the third-party user may also provide particular indicia of their own for the video files and or video clips. Furthermore, it is contemplated that the third party users may leave a comment for the active user, send a direct message to the user and/or provide a rating for the video grid as a whole or based on specific individual clip.

Finally, the first set of files comprising the video grid may now serve as seed or root, since its contents and/or layout may be continuously updated based on the favorability of the feedback received from social media users. Thus, a highly favorable set of files associated with the particular indicia, such as keyword “wedding” has a greater likelihood of being ranked near the top search results, if a user were to search far that term. Therefore, at Step 714, the system 100 updates a social media index, which may be defined as a numerical or graphic indicator of the video grid's (or the user's) favorability by social media users. Finally, the system 100 modifies the video grid in response to the social media index, (Step 716),

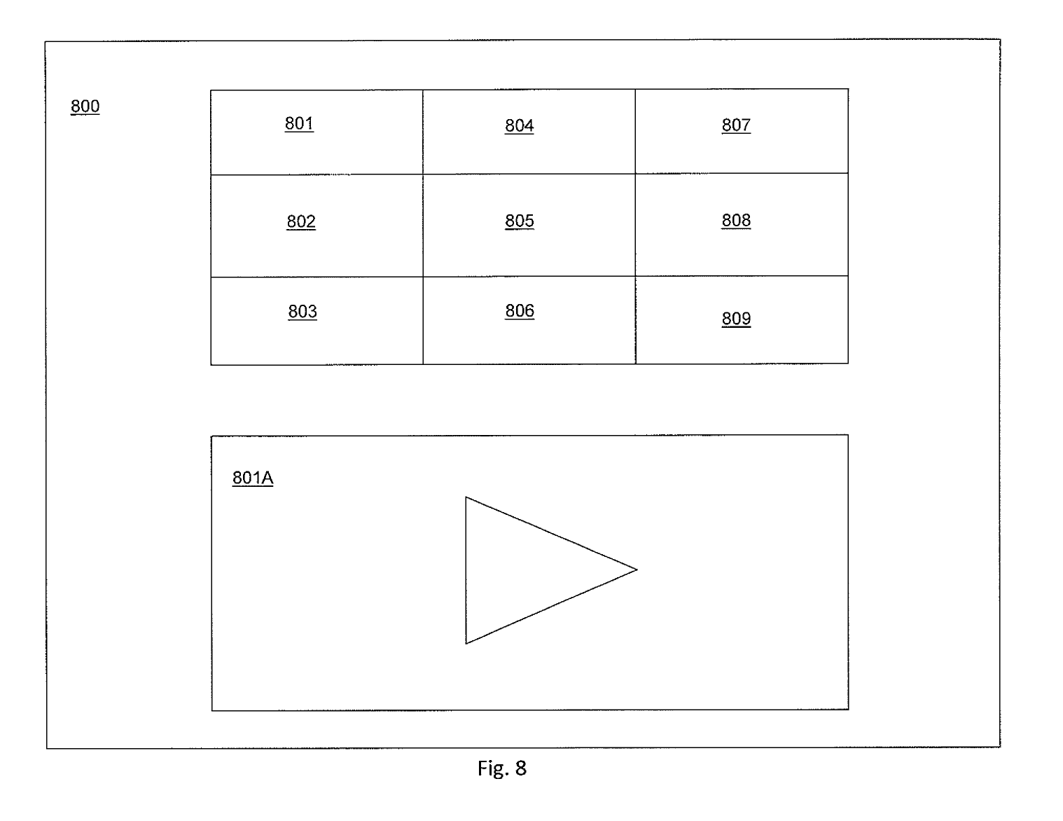

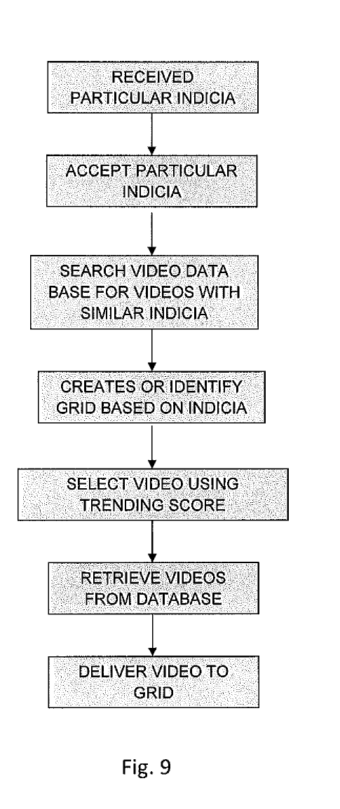

FIG. 8 and FIG. 9 are directed to the method of automatically assembling several documents on a grid formation from different users based on particular indicia. As described above, the multiple video clips 406 may be uploaded by a single active user or may be the result of a contribution of two or more active users. Therefore, the Multi-Video Sharing System 100 is provided with control system that captures the identifiers or particular indicia and associates each indicia with the highest trending scores and displays them on a constantly updating grid.

Once the user successfully uploads the video files along with the corresponding particular indicia the control system simultaneously verifies if the particular indicia is not found on the database in order to create a template of a grid formation or arranges the video files into a previously created grid formation associated with the particular indicia.

As shown in FIG. 8, a template of grid formation 800 is created as result of particular indicia wherein each segment contains video files belonging to different users 802-809. A user's video file may be projected as a single video clip 801A allowing for easier identification of his/her related video file linked to the particular indicia. As shown in the exemplary embodiment of FIG. 8, the order of video files in the grid formation may depend on the trending scores.

FIG. 9 shows the process which controls the generation and selection of video files in the Multi-Video Sharing System 100. As described earlier, once the video file is uploaded to the database, the control system may receive the uploaded particular indicia and start searching for previously submitted indicia. If the search does not produce a match, the control system generates a grid formation related to the new particular indicia. On the other hand, if the uploaded particular indicia matches a previously submitted indicia, a grid formation is identified. Furthermore, the control system may select video based on trending scores. In return, the system may upload the selected video and add it to the grid associated with the indicia.

It will be apparent to those skilled in the art that various modifications and variations can be made to the method and system described in the present disclosure. Other embodiments of the method and system will be apparent to those skilled in the art upon consideration of the specification and practice of the method and system disclosed herein. It is intended that the specification and examples be considered as exemplary only, with a true scope of the disclosure being indicated by the following claims.

1. A computer-readable medium, tangibly embodied, including instructions for:
receiving log-in information from a first user;
receiving a first plurality of video files from the first user;
defining a first array of video clips based on each received video files;
individually playing said first array of video clips simultaneously;
receiving a second plurality of video files from a second user, wherein the second plurality of video files comprises at least one identifier associated with at least one video file;
calculating a first social media index based on the received second plurality of video files and the at least one identifier; and
defining a second array of clips based on the calculated social media index.

2. The computer-readable medium of claim 1, further including instructions for individually playing said second array of video clips simultaneously.

3. The computer-readable medium of claim 1, wherein receiving a first plurality of video files from a user further comprises receiving setting preferences from said user.

4. The computer-readable medium of claim 3, wherein the setting preferences comprise preferred dimension for the first array of video clips.

5. The computer-readable medium of claim 4, wherein the setting preferences comprise background information associated with the first array of video clips.

6. The computer-readable medium of claim 5, wherein the background information comprises a background image.

7. The computer-readable medium of claim 2, wherein the first user individually plays each video file on a first computing platform.

8. The computer-readable medium of claim 7, wherein the second user individually plays each video file on a second computing platform.

9. The computer-readable medium of claim 8, wherein the first computing platform and the second computing platform are of different type.

10. (canceled)

11. (canceled)

12. (canceled)

13. (canceled)

14. (canceled)

15. (canceled)

16. (canceled)

17. (canceled)

18. A computer system, comprising:
a first computing platform;
at least one input device; and
a central processing unit in communication with the platform and the at least one input device, the central processing unit configured to:
receive log-in information from a first user at the first platform;
receive a first plurality of video files from the first user;
define a first array of video clips based on the received video files;
individually play each video file on said first array of video clips simultaneously and synchronously;
receive a second plurality of video files from a second user, wherein the second plurality of video files comprises at least one keyword associated with at least one video file;
calculate a first social media index at least partially based on the received second plurality of video files and the at least one identifier; and
define a second array of video files based on the calculated social media index.

19. The computer system of claim 18, wherein the central processing unit is further configured to individually play each video file on said second array of video clips simultaneously.

20. The computer system of claim 19, wherein the second user individually plays each video file on a second computing platform, and wherein said second computing platform is of a different type than the first computing platform.

21. A non-transitory computer-readable medium comprising instructions for:
creating a profile associated with a first user;
maintaining one or more video files associated with the profile;
defining a first array comprising a first plurality of video clips based on the one or more video files;
individually playing each one of the first plurality of video clips on the first array simultaneously on a display;
calculating a social media index associated with at least one of the first plurality of video clips; and
defining a second array comprising a second plurality of video clips, the second array based on the social media index.

22. The method of claim 21, further comprising individually playing the video clips on the second array simultaneously on the display.

23. The method of claim 21, wherein the social media index is based on feedback from a second user.

24. The method of claim 21, wherein each one of the first plurality of video clips is associated with an identifier.

25. The method of claim 24, wherein said identifier comprises a keyword.

26. The method of claim 21, wherein the second array is further defined based on an identifier associated with a video clip.

27. (canceled)

28. (canceled)

29. (canceled)

30. (canceled)

31. (canceled)

32. (canceled)
